(19) United States
(12) Patent Application Publication
(10) Pub. No.: US 2017/0276142 A1
(43) Pub. Date: Sep. 28, 2017

(54) Clearance reducing system, appratus and method

(71) Applicant: Gregory Graham, Ventura, CA (US)

(72) Inventor: Gregory Graham, Ventura, CA (US)

(21) Appl. No.: 14/999,061

(22) Filed: Mar. 24, 2016

(51) Int. Cl. F04D 29/02; F04D 29/42; F04D 29/053; F04D 17/10; F04D 25/02

(52) U.S. Cl. CPC F04D 29/023; F04D 17/10; F04D 25/02; F04D 29/053; F04D 29/4206; B05D 1/02

(57) ABSTRACT

A clearance reducing system for turbomachinery is provided. In one embodiment, a turbomachinery apparatus having a shaft rotatable about an axis, with an impeller coupled to the shaft for rotation about the axis and a shroud positioned over at least a portion of the impeller is provided. The impeller includes a hub with a plurality of impeller blades projecting from the hub. An erodible element containing a mixture of a polymer with a first density and a filler with a second density, with the second density greater than the first density is also provided. The erodible element is located on a portion of the shroud opposite the impeller blades and structured to erode when contacted by the plurality of impeller blades.

### FIELD OF THE INVENTION

The present invention relates generally to clearance reducing systems having the ability to wear without damaging components if clearances are excessively close. More particularly, the invention concerns an erodible coating system, methods for making such a system, and to compressor components, and other devices and apparatus incorporating such a system.

### BACKGROUND OF THE INVENTION

Compressors have existed for many years, and there exist many different designs. A compressor includes a compressor wheel, or impeller having a plurality of spaced apart blades. The impeller is rotated about an axis within a compressor housing and receives air from an inlet. The impeller then accelerates and compresses the air, and then discharges the air through an outlet. To be most efficient, the air is forced to flow between a space defined by the impeller blades, the rotational hub of the impeller and a portion of the compressor housing commonly referred to as a compressor shroud. The shroud is positioned adjacent to the impeller blades opposite the hub.

Compressor efficiency is often greatest when a minimal clearance is maintained between the shroud and the impeller blades to prevent leakage of the air over the top of the blades. However, during normal operation of the compressor, centrifugal forces acting on the impeller cause it to “grow” radially in the direction of the shroud. In addition, during operation of the impeller at speed, vibrations of the impeller drive shaft can occur resulting in axial and radial movement of the impeller. The axial and radial vibration, as well as the radial “growth” of the impeller blades can result in the blades touching the compressor shroud, damaging the blades and causing a failure of the compressor.

Therefore, there remains a need to overcome one or more of the limitations in the above-described, existing art.

### BRIEF DESCRIPTION OF THE DRAWINGS

FIG. 1 comprises a perspective view of a portion of a centrifugal compressor embodying the principals of the invention;

FIG. 2 comprises a perspective cross-sectional view of the embodiment of FIG. 1;

FIG. 3 comprises an elevation cross-sectional view of view of the embodiment of FIG. 1

FIG. 4 comprises a perspective view of the inner surface of the compressor housing that is part of the embodiment of FIG. 1; and

FIG. 5 comprises an elevation cross-sectional view of the embodiment of FIG. 3, showing a close-up of half of the embodiment of FIG. 3.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE PREFERRED EMBODIMENTS

In the following description, for the purposes of explanation, numerous specific details are set forth in order to provide a thorough understanding of the clearance reducing system (CRS) of the present invention. It will be apparent, however, to one skilled in the art that the clearance reducing system may be practiced without some of these specific details. Throughout this description, the embodiments and examples shown should be considered as exemplars, rather than as limitations on the clearance reducing system. That is, the following description provides examples, and the accompanying drawings show various examples for the purposes of illustration. However, these examples should not be construed in a limiting sense as they are merely intended to provide examples of the clearance reducing system rather than to provide an exhaustive list of all possible implementations of the clearance reducing system (CRS).

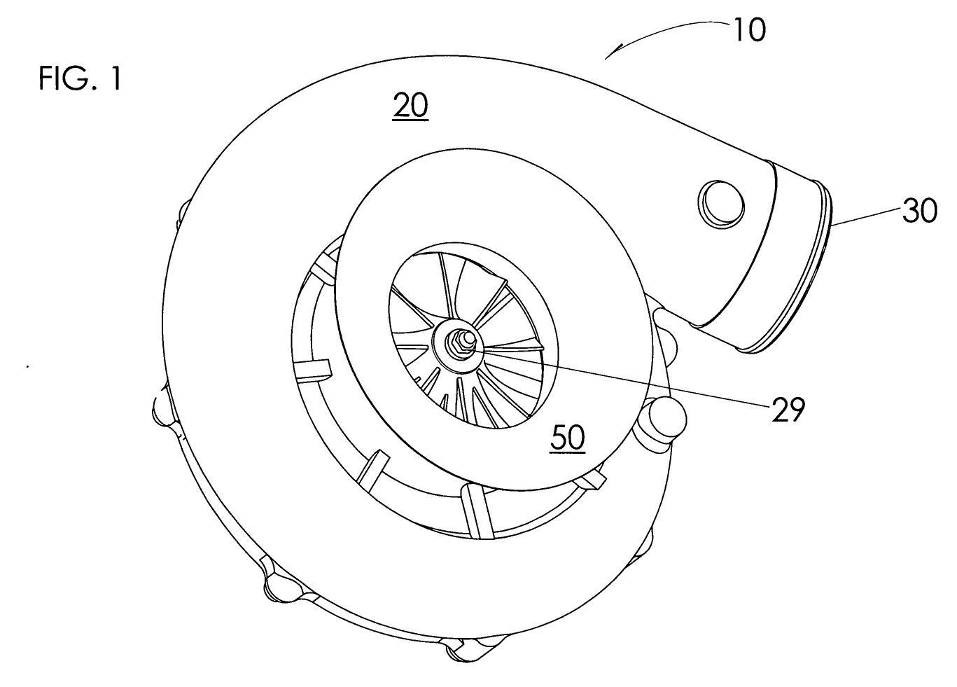

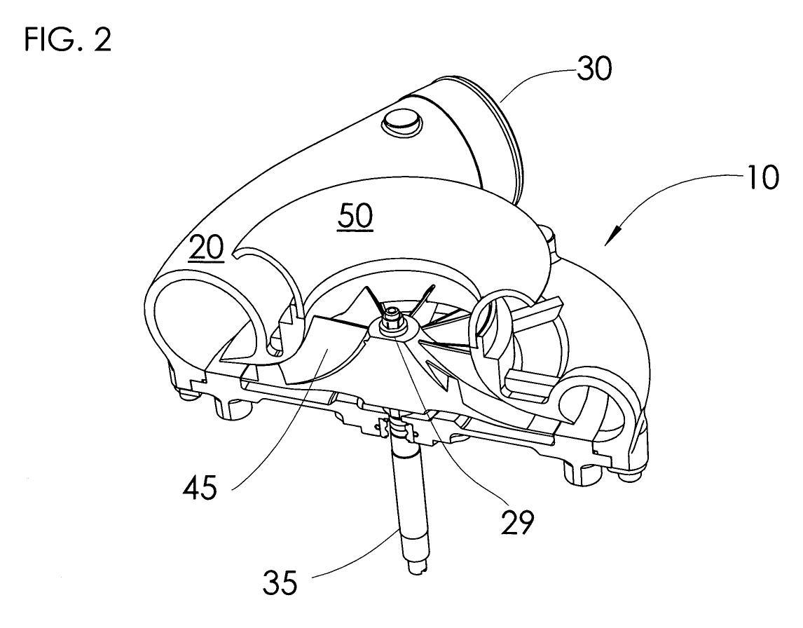

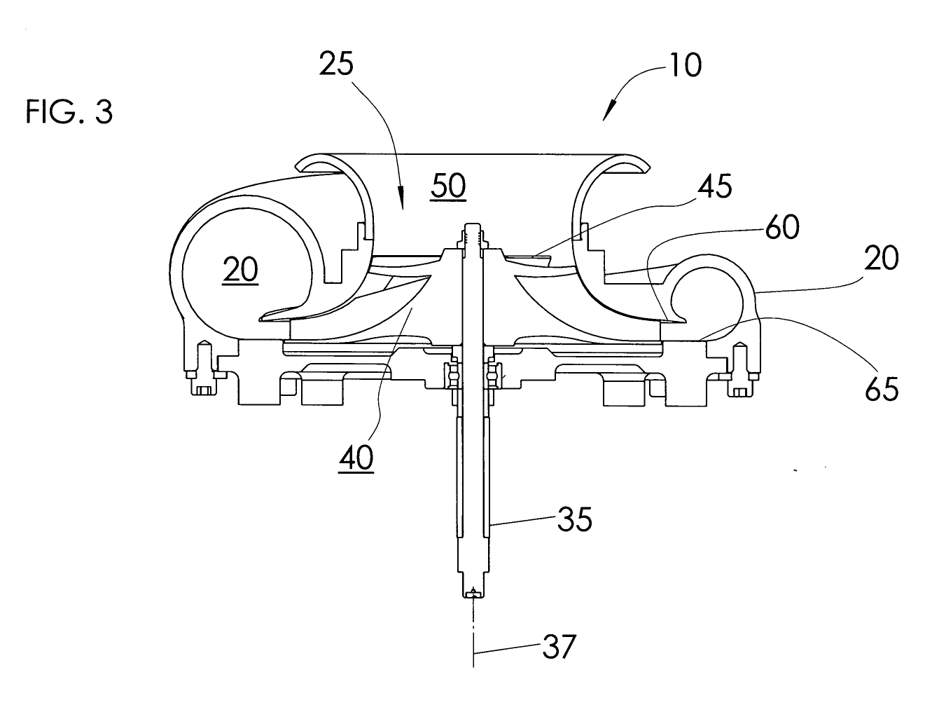

Referring now to FIGS. 1-5, the clearance reducing system (CRS) includes many novel features including, among others, the ability to manufacture turbomachinery components having higher efficiencies and longer lifespans than conventional turbomachinery components. In addition, the CRS 10 is inexpensive to manufacture, and when ingested by turbomachinery components, or any other downstream components, the CRS will cause no damage.

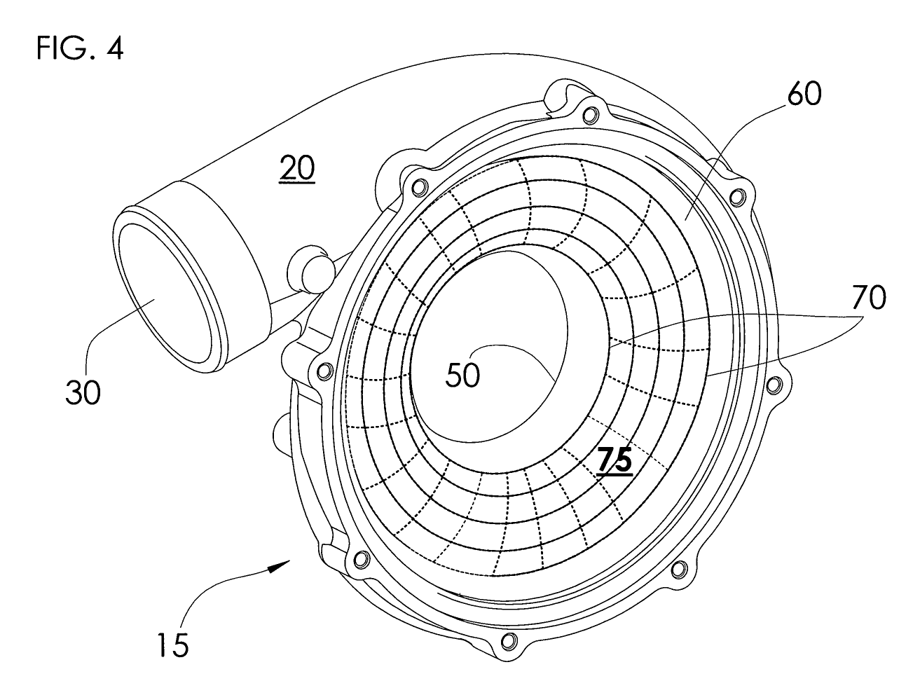

In one embodiment, the CRS comprises a relatively soft coating 75 (shown in FIG. 4) as compared to the impeller wheel 25 or compressor housing 15. The CRS 75 can be used as a gap reduction material for reducing clearances between moving components. For example, the CRS 75 may be applied to the inner surface of a compressor housing 15, opposite the impeller wheel 25, enabling a smaller gap between the two components. As the gap between the blades of the impeller wheel 25 and the compressor housing 15 inner surface affects the overall performance of the compressor, a reduced gap increases efficiency. The CRS 75 also provides a low-friction surface and is resistant to solvents and oils.

Referring now to FIG. 1, a portion of a turbomachinery apparatus is illustrated. Generally, “turbomachinery” describes machines that transfer energy between a rotor and a fluid, including both turbines and compressors. While a turbine transfers energy from a fluid to a rotor, a compressor transfers energy from a rotor to a fluid. For example, centrifugal compressors, axial compressors, and specific examples of these types of compressors, such as turbochargers, superchargers, turbojets, turboprops and turbofans can all be considered turbomachinery. The CRS can be applied to turbomachinery components, as well as pumps, fans, blowers, pistons, and other surfaces that receive wear during operation.

As shown in FIGS. 1-5, a portion of a centrifugal compressor 10 is illustrated. A compressor housing 15 includes a volute 20 that is the component that receives the fluid being pumped by the impeller 25. The volute is a curved funnel that increases in area as it approaches the annular outlet or discharge port 30. The volute converts kinetic energy into pressure by reducing speed while increasing pressure.

The impeller 25 is rotatably mounted by bearings 27 and a fastener 29 to a shaft 35 that rotates about an axis 37, with the impeller 25 having a hub 40 and a plurality of impeller blades 45 projecting from the hub 40. Shaft 35 terminates at fastener 29, resulting in an impeller 25 mounted to the shaft 35 in a “cantilevered” arrangement. That is, the end of the shaft 35 at the fastener 29 is not attached to any structure. As a result, in some instances, for example, when the shaft 35, fastener 29 and the impeller 25 are rotating, the shaft 35 may experience axial and radial deflection causing the impeller 25 and fastener 29 to “wobble” or oscillate. Also, any imbalance of the impeller wheel 25 and other rotating components can also contribute to axial and radial deflection of the shaft 35.

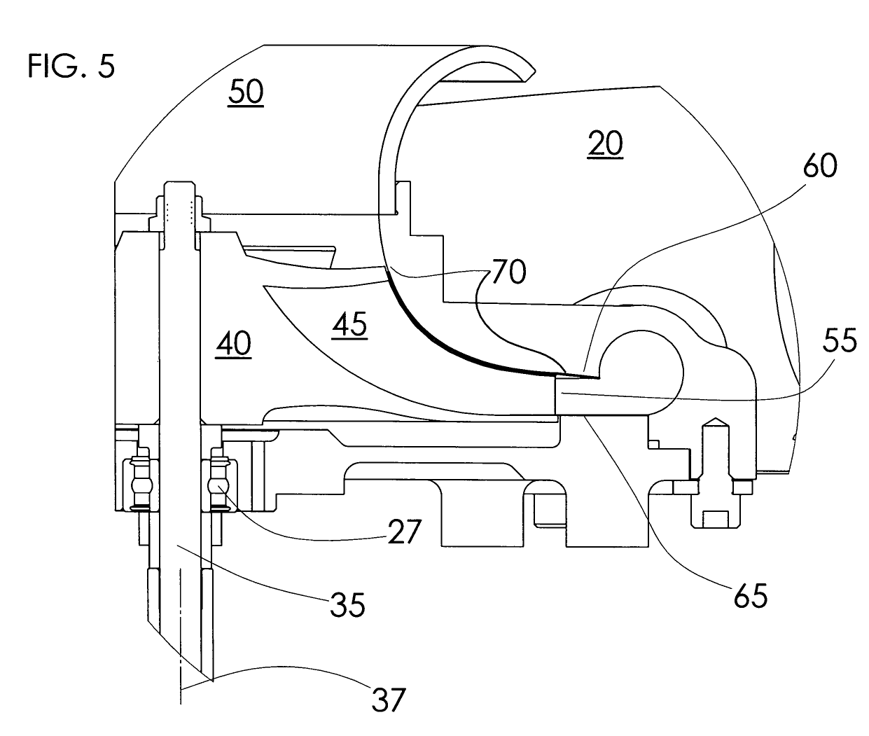

Referring now to FIG. 5, the compressor housing 15 includes an axial inlet 50 through which a fluid, such as air, passes. Downstream of the impeller 25 in the fluid flow path, is a diffuser 55 comprised of an upper wall 60, and a lower wall 65. The diffuser 55 is located within the compressor housing 15 and serves to convert the kinetic energy (i.e., the high velocity) of the fluid into pressure by gradually slowing (diffusing) the fluid. Diffusers 55 can include vanes (not shown) or be vaneless (shown).

Referring now to FIG. 4, an interior view of the compressor housing 15 is illustrated. As shown, a curved, annular surface extends from the axial inlet 50 to the upper wall 60 of the diffuser 55. This curved, annular surface is also shown in cross-section in FIG. 5. Shroud area 70 is comprised of a portion of the curved, annular surface of the compressor housing 15. In one embodiment, the shroud area 70 is located opposite the impeller blades 45 and in close proximity to the impeller blades 45 which sweep next to the shroud area 70 as the impeller 40 rotates. For example, the shroud area 70 extends anywhere the impeller blades 45 are located at a distance of less than 0.050 of an inch from the curved, annular surface of the compressor housing 15. In other embodiments, the shroud area 70 may only be located where the impeller blade 45 clearance with the curved, annular surface of the compressor housing 15 is less than 0.040 of an inch. Alternatively, the shroud area 70 may be located in an area anywhere opposite the impeller blades 45.

As shown in FIGS. 4 and 5, a wear coating 75 is located on the shroud area 70. The shroud area 70 designates the surface where the wear coating 75 is located. In one embodiment, the wear coating 75 comprises a mixture of a polymer and a filler. Polymers are large molecules, or macromolecules, composed of many repeated subunits. In a preferred embodiment, a thermosetting polyimide polymer resin is employed, having a density that can range from 1 to 1.5 grams per cubic centimeter. In this embodiment, P84 polyimide moulding powder is employed, manufactured by HP Polymer GmbH. In other embodiments, an epoxy resin or a silicone resin may be employed.

The second component of the wear coating 75 is a filler, which may be comprised of a polytetrafluoroethylene (PTFE), or organic powders such as cellulose or other powders comprised of organic material, or walnut shells or other non-metallic, non-alloy and non-ceramic elements. As defined herein, a filler is a component that takes up space but does not provide any structural strength. That is, if the filler was removed, the structural strength (i.e., tensile strength) of the mixture would remain substantially the same or possibly increase. In contrast, in a case where a filler provides structural strength, removal of the filler results in a decrease of the tensile strength of the mixture.

In a preferred embodiment, PTFE is employed as the second component of the wear coating 75, in the form of a fluorocarbon solid having a density that can range from 2 to 3 grams per cubic centimeter. In this embodiment, FLON-3610 manufactured by Flontech USA of Pittston, Pa. is used. One feature of PTFE is that it has one of the lowest coefficients of friction of any solid and is also very non-reactive. For example, the coefficient of friction of PTFE may be about 0.04. The coefficient of friction is the ratio of the frictional force divided by the normal force. The coefficient of friction has no units of measure (force divided by force). When compared to materials used in conventional abradable coatings, the coefficient of friction of PTFE is significantly lower. For example, the coefficient of friction of aluminum may range from 1.05 to 1.35. The coefficient of friction of carbon may range from 0.14 to 0.16. The coefficient of friction of steel may range from 0.5 to 0.8. The low coefficient of friction of PTFE in the present invention provides an advantage when compared to conventional abradable coatings.

In one embodiment, the wear coating 75 is manufactured by generating a first mixture comprising polytetrafluoroethylene (PTFE) and a solvent, where the PTFE is added to the solvent and then the mixture is agitated resulting in a heterogeneous mixture of PTFE and the solvent. A second mixture is then generated, the second mixture comprising a polymer and the solvent, where the polymer is added to the solvent and then the mixture is agitated resulting in a homogeneous mixture. A final mixture is then produced by adding the first mixture to the second mixture, where a weight of the PTFE added to the second mixture can range from 30% more to 30% less than a weight of the second mixture.

Several solvents may be employed, including N-Methyl-2-pyrrolidone (NMP), methyl ethyl ketone (MEK), butanone, benzene, toluene, and others. In a preferred embodiment, NMP is employed, which is an organic compound and is miscible with water and with most common organic solvents. NMP is a common paint solvent readily available from chemical supply houses such as Ashland Chemical.

In a preferred embodiment, the first mixture of PTFE and the NMP solvent are prepared by adding PTFE particles to the liquid NMP solvent. The PTFE particles may range in size from 150 microns to 400 microns. Agitation of the solution allows the PTFE particles to separate and create a uniform particulate distribution. By weight preparation of the PTFE and the NMP solvent is made by mixing 28 grams (1 ounce) of PTFE particles added to 8.3 (0.3 ounces) grams of NMP.

In a separate container, preparation of the polymer, the polyimide moulding powder discussed above and the NMP solvent is made by mixing by weight for a 30% polyimide to NMP solvent ratio. Allowing this solution to sit overnight will allow the polyimide powder to dissolve completely in the NMP solvent resulting in a homogenous solution. By weight preparation of the polyimide powder and the NMP solvent is made by mixing 6 grams (0.21 ounces) of polyimide powder to 14 grams (0.5 ounces) of NMP to create the solution.

Finally, the first mixture of NMP and PTFE (a heterogeneous mixture) is added to the second mixture of NMP and polyimide powder (a homogenous mixture) resulting in the wear coating 75. The heterogeneous PTFE mixture is mixed in at a 1:1 ratio by weight with the homogenous polyimide solution. For example, for each 28 grams of polyimide solution, 28 grams of PTFE is mixed in. That is, a weight of the PTFE added is equivalent to a weight of the second homogenous solution. It will be appreciated that other mixture amounts may be employed. For example, a weight of the PTFE added to the second homogenous mixture can range from 30% more to 30% less than a weight of the second homogenous mixture. Put differently, the amount of PTFE in the mixture may range from 30% by weight up to 70% by weight of the total mixture. Alternate percentages of the given materials will provide for slightly different characteristics of toughness and scrape-ability. The homogenous polyimide solution will become thicker with more PTFE powder mixed in. At 33% PTFE powder to NMP solvent the material will be very thick, with the cured material being thicker and it is more difficult to mix in the filler material, in this case PTFE. With a thicker material the final mixture is paste-like, enabling application by brush or spatula. A thinner homogenous solution of polyimide and NMP, such as 10% by weight will result in a final material that is easier to “scrape off” a surface the mixture is applied to. This thinner mixture will absorb the PTFE more readily and a paint spay gun may be employed to apply the mixture to a surface.

It will also be appreciated that the above-discussed amounts can be “scaled up” to create larger batches of mixture. An optional embodiment wear coating 75 mixture may also include carbon black, used as a color pigment. Carbon black is a material produced by the incomplete combustion of heavy petroleum products such as FCC tar, coal tar, ethylene cracking tar, and a small amount from vegetable oil, and is commonly available.

The wear coating 75 is then applied to the shroud area 70. In a preferred embodiment, the wear coating 74 is applied by spraying, similar to spraying paint or applying a texture coating. Other embodiments of the wear coating 74 may be applied by “squeegee,” brushing or other methods. The compressor housing 15 is preheated to approximately 200-300 degrees Fahrenheit, then a layer of the wear coating 75 is sprayed onto the shroud area 70 and allowed to dry, during which some of the NMP solvent evaporates. This results in a partially cured layer, allowing another layer of the wear coating 75 to be applied to the shroud area 70. Each layer is several thousands of an inch thick. Once the desired thickness is achieved, the wear coating 75 is cured in an oven at 500 degrees Fahrenheit. One feature of the present invention is that the temperature that the wear coating 75 can withstand is directly related to the final curing temperature. For example, if the final curing temperature is 500 degrees Fahrenheit, then the wear coating 75 can withstand 500 degrees Fahrenheit in service. The final curing temperature can go up to 650 degrees Fahrenheit.

An applied thickness of the wear coating 75 can vary depending upon the application. For example, in the illustrated embodiment shown in FIGS. 1-5, the wear coating 75 may have a thickness ranging from 0.003 to 0.050 of an inch. In another example, the wear coating 75 may be applied to the tips of the impeller blades 45 rather than to the shroud area 70. One advantage of the present invention is that with the application of the wear coating 75, the space between the impeller blades 45 and the shroud area 70 can be reduced. For example, in a conventional centrifugal compressor that does not have a wear coating 75, the space between the impeller blades 45 and the shroud area 70 can range from 0.025 of an inch to 0.045 of an inch. With the wear coating 75 installed on the shroud area 70, the space from the impeller blades 45 to the shroud area 70 can be decreased down to 0.005 of an inch.

There are several advantages of installing the wear coating 75 of the present invention. For example, when building a compressor or other types of turbomachinery, concentricity is never perfect between the various parts as multiple components are used. In the centrifugal compressor 10 perfect concentricity is unlikely to occur between the compressor housing 15 and the impeller 25. With the wear coating 75 installed the impeller blades 45 will scrape, or erode the wear coating 75 during initial operation, enabling the manufacture of a centrifugal compressor 10 having smaller gaps, or clearances between the impeller blades 45 and the shroud area 70 than conventional centrifugal compressors. The performance of turbomachinery such as a centrifugal compressor 10, or other types of turbomachinery is directly affected by the size of the gap between the impeller blades 25 and the shroud area 70. The impeller 25 rotates at extremely high speed and cannot touch the stationary shroud area 70. A space or gap is required so these parts never touch. The smaller the space or gap between the moving and non-moving parts the higher the efficiency of the turbomachinery.

For example, as illustrated in FIGS. 1-5, and discussed above, the impeller 25 is rotatably mounted by bearings 27 and a fastener 29 to a shaft 35 that rotates about an axis 37, with the impeller 25 having a hub 40 and a plurality of impeller blades 45 projecting from the hub 40. Shaft 35 terminates at fastener 29, resulting in an impeller 25 mounted to the shaft 35 in a “cantilevered” arrangement. That is, the end of the shaft 35 at the fastener 29 is not attached to any structure. As a result, in some instances, for example, when the shaft 35, fastener 29 and the impeller 25 are rotating the shaft 35 may experience axial and radial deflection causing the impeller 25 and fastener 29 to “wobble” or oscillate. Imbalance of the impeller 25 and other rotating components can also cause axial and radial deflection of the shaft 35. This radial deflection can result in the impeller blades 45 contacting the shroud 70 and damaging the impeller blades 45. One feature of the present invention, when the wear coating 75 is located on the shroud 70 opposite the impeller blades 45, radial movement of the impeller 25, resulting in the impeller blades 45 contacting the wear coating 75, erodes the wear coating 75, and minimizes damage to the impeller blades 45.

One feature of the present invention is that the wear coating 75 is positioned between the moving and non-moving parts allowing the gap to be minimized, thereby increasing efficiency. The moving and non-moving parts are typically aluminum alloys. The wear coating 75 placed between these two parts is capable of being scraped, or eroded off by the moving part, such as the impeller blades 45 without damaging them. In addition, the portion of the wear coating 75 that is scraped off, or eroded, will not harm any other components located downstream. For example, the centrifugal compressor 10 may be installed on an internal combustion (IC) engine. The wear coating 75 is not harmful to the pistons, valves, bearings or other IC engine components located downstream of the centrifugal compressor 10. This is in contrast to conventional abradable coatings that contain carbon fiber, metals, metal foams, fiberglass, ceramics (such as aluminum oxides), glass, glass-ceramics, ceramic-metal composites and other combinations and materials which damage internal combustion engines.

Another feature of the present invention is ease of manufacture and low manufacturing and component cost. In contrast to conventional ablative coating systems that use exotic materials such as carbon fiber and ceramics, the materials used in the present invention are low cost and easy to obtain. In addition, conventional ablative coating systems require exotic manufacturing methods, such as vapor deposition, plasma spray coating and autoclaves. The present invention can be applied using a convention paint spray gun, or other simple methods.

Thus, it is seen that a clearance reducing system, apparatus and method is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. An apparatus comprising:
a shaft rotatable about an axis;
an impeller coupled to the shaft for rotation about the axis;
a shroud positioned over at least a portion of the impeller, the impeller having a hub with a plurality of impeller blades projecting from the hub; and
an erodible element comprising a mixture of a polymer having a first density and a filler having a second density, with the second density greater than the first density, the erodible element located on a portion of the shroud opposite the impeller blades and structured to erode when contacted by the plurality of impeller blades.

2. The apparatus of claim 1, where the shroud comprises a portion of a compressor housing having an axial inlet and an annular outlet volute, with the impeller being rotatably mounted within the compressor housing between the axial inlet and the annular outlet volute;
the axial inlet being defined by a tubular inlet portion of the compressor housing and the annular outlet volute being defined by an annular diffuser passage surrounding the impeller, the diffuser having an annular outlet communicating with the outlet volute; and
the shroud defining a portion of an inner wall of the compressor housing, the shroud opposite the impeller blades and in close proximity to the impeller blades which sweep next to the inner wall portion as the impeller rotates.

3. The apparatus of claim 1, where the shaft is rotatably driven by a belt or a gear that is rotatably coupled to an internal combustion engine.

4. The apparatus of claim 3, where the erodible coating includes a characteristic of when the impeller blades contact the erodible coating, a portion of the erodible coating is removed and passes though at least a portion of the internal combustion engine without damaging the internal combustion engine.

5. The apparatus of claim 1, where the polymer is selected from a group consisting of: a polyimide, an epoxy and a silicone.

6. The apparatus of claim 1, where the filler is selected from a group consisting of: a polytetrafluoroethylene (PTFE), an organic powder, and a multiplicity of walnut shells.

7. The apparatus of claim 1, where a density of the polymer can range from 1 to 1.5 grams per cubic centimeter, and a density of the filler can range from 2 to 3 grams per cubic centimeter.

8. The apparatus of claim 1, where the polymer comprises a thermosettable polyimide material.

9. The apparatus of claim 1, where the filler comprises a multiplicity of particles that range from 150 microns to 400 microns.

10. An article of manufacture comprising:
a first mixture comprising polytetrafluoroethylene (PTFE) and a solvent, where the PTFE is added to the solvent and then the mixture is agitated resulting in a heterogeneous mixture of PTFE and the solvent;
a second mixture comprising a polymer and the solvent, where the polymer is added to the solvent and then the mixture is agitated resulting in a homogeneous mixture; and
a final mixture produced by adding the first mixture to the second mixture, where a weight of the PTFE added to the second mixture can range from 30% more to 30% less than a weight of the second mixture.

11. The article of manufacture of claim 10, where the solvent is selected from a group consisting of: N-Methyl-2-pyrrolidone (NMP), methyl ethyl ketone (MEK), butanone, benzene, and toluene.

12. The article of manufacture. of claim 10, where the polymer is selected from a group consisting of: a polyimide, an epoxy and a silicone.

13. The article of manufacture of claim 10, where the final mixture is produced by adding the first mixture to the second mixture, so that a weight of the PTFE added is equivalent to a weight of the second mixture.

14. The article of manufacture of claim 10, where the final mixture is applied to a turbomachinery element in the following steps:
preheating the turbomachinery element to approximately 225 degrees Fahrenheit;
spraying a layer of the final mixture onto the preheated turbomachinery element;
drying the sprayed layer; and
repeating the spraying and drying steps until a desired thickness of the final mixture is obtained.

15. An turbomachine apparatus comprising:
a shaft rotatable about an axis;
a compressor comprising an impeller coupled to the shaft for rotation about the axis, the impeller having a hub with a plurality of impeller blades projecting from the hub, the impeller, hub and impeller blades subject to a radial oscillation due to a deflection of the shaft during shaft rotation;
a compressor housing having an axial inlet and an annular outlet volute, with the impeller being rotatably mounted within the compressor housing between the axial inlet and the annular outlet volute;
a shroud comprising a portion of an inner wall of the compressor housing, the shroud opposite the impeller blades and in close proximity to the impeller blades which sweep next to the shroud as the impeller rotates, the shroud having a coating, the coating comprising:
an erodible element comprising a mixture of a polymer having a first density and a filler having a second density, with the second density greater than the first density; and
where the erodible element is structured to erode when contacted by the plurality of impeller blades when the shaft deflects during shaft rotation.

16. The turbomachine apparatus of claim 15, where the shaft is rotatably driven by a belt or a gear that is rotatably coupled to an internal combustion engine.

17. The turbomachine apparatus of claim 15, where the erodible coating includes a characteristic of when the impeller blades contact the erodible coating, a portion of the erodible coating is removed and passes though at least a portion of the internal combustion engine without damaging the internal combustion engine.

18. The turbomachine apparatus of claim 15, where the polymer is selected from a group consisting of: a polyimide, an epoxy and a silicone.

19. The turbomachine apparatus of claim 15, where the filler is selected from a group consisting of: a polytetrafluoroethylene (PTFE), an organic powder, and a multiplicity of walnut shells.

20. The turbomachine apparatus of claim 15, where a density of the polymer can range from 1 to 1.5 grams per cubic centimeter, and a density of the filler can range from 2 to 3 grams per cubic centimeter.
